(19) United States
(12) Patent Application Publication
(10) Pub. No.: US 2021/0291675 A1
(43) Pub. Date: Sep. 23, 2021

(54) VEHICLE

(71) Applicants: TOYOTA JIDOSHA KABUSHIKI KAISHA, Aichi (JP); SUBARU CORPORATION, Tokyo (JP)

(72) Inventors: Tatsuya OGAWA, Toyota-shi (JP); Akihiro OOBAYASHI, Shibuya-ku (JP)

(21) Appl. No.: 17/194,320

(22) Filed: Mar. 8, 2021

(30) Foreign Application Priority Data
Mar. 19, 2020 (JP) 2020-050190

(51) Int. Cl. B60L 53/16; B60R 13/04

(52) U.S. Cl. CPC B60L 53/16; B60R 13/04

(57) ABSTRACT

A vehicle may include an inlet provided in a vehicle body and through which energy is supplied to the vehicle; a lid covering the inlet; and a garnish constituted of resin. The garnish may cover at least a part of the vehicle body and at least a part of the lid. Arranging the lid within a range of the garnish increases a degree of freedom in layout of the inlet. The increase in the degree of freedom in the layout of the inlet means an increase in a degree of freedom in component arrangement within the vehicle body. Therefore, spatial efficiency inside the vehicle body may be improved.

### CROSS-REFERENCE TO RELATED APPLICATION

This application claims priority to Japanese Patent Application No. 2020-050190 filed on Mar. 19, 2020, the contents of which are hereby incorporated by reference into the present application.

### TECHNICAL FIELD

The art disclosed herein relates to a vehicle comprising a garnish on its body.

### BACKGROUND

A garnish constituted of resin may be attached to a vehicle body for decorative purposes or for protection of the body. For example, Japanese Patent Application Publication No. 2014-91394 describes a vehicle to which a garnish is attached. A garnish attached to an outer side of a vehicle body may be called an outer garnish. The garnish may also be called automotive molding. In the disclosure herein, the outer garnish is simply termed a garnish.

### SUMMARY

An inlet through which energy for vehicle propulsion is supplied is also provided in a vehicle body. The energy may, for example, be gasoline, electricity, or hydrogen. The inlet for energy is covered by a lid. Conventionally, a garnish has not been attached to the lid covering the inlet.

A vehicle disclosed herein may comprise an inlet provided in a vehicle body and through which energy is supplied to the vehicle, a lid covering the inlet, and a garnish constituted of resin. The garnish may cover at least a part of the vehicle body and at least a part of the lid. Arranging the lid within a range of the garnish increases a degree of freedom in layout of the inlet. The increase in the degree of freedom in the layout of the inlet means an increase in a degree of freedom in component arrangement within the vehicle body. Therefore, spatial efficiency inside the vehicle body may be improved.

A border of the garnish may extend continuously from the vehicle body over to the lid in a straight line or a curved line. Since the border of the garnish on the vehicle body is continuous with the border of the garnish on the lid, the appearance of the vehicle body is improved aesthetically.

At least a part of a border of the lid may overlap the border of the garnish. For example, an upper portion and/or a side portion of the border of the lid may overlap the border of the garnish. Thereby, the number of visible lines on the vehicle body is less, and thus the appearance of the vehicle body is improved aesthetically.

Details and further improvements of the technique disclosed herein will be described in Detailed Description below.

### BRIEF DESCRIPTION OF DRAWINGS

FIG. 1 is a side view of a front part of a vehicle according to an embodiment.

FIG. 2 is a side view of a front part of a vehicle according to a first variant of the embodiment.

FIG. 3 is a side view of a front part of a vehicle according to a second variant of the embodiment.

FIG. 4 is an enlarged side view of a front part of a vehicle according to a third variant of the embodiment.

### DETAILED DESCRIPTION

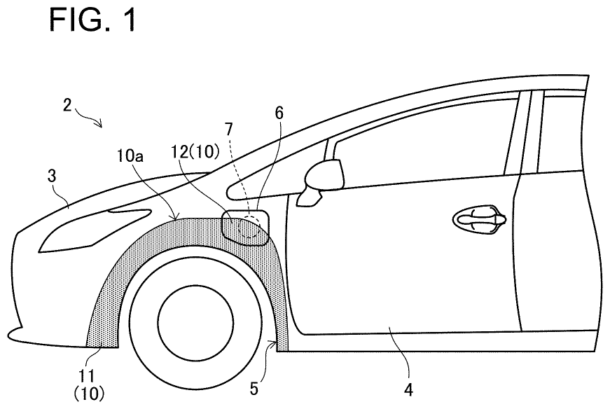

A vehicle 2 according to an embodiment will be described with reference to the drawings. The vehicle 2 is an electric vehicle including an electric traction motor and a battery. FIG. 1 shows a left side view of a front part of the vehicle 2. An inlet through which electricity is supplied and a lid is provided on a left side surface of a body 3 of the vehicle 2. The lid 6 covers the inlet 7. The inlet 7 is connected to an electric power converter (not shown). Electricity supplied through the inlet 7 is converted by the electric power converter into suitable electricity to charge the battery. The battery is charged by the electricity supplied through the inlet 7. The vehicle 2 is configured to travel by the electricity of the battery. The inlet 7 is an opening through which the energy for propulsion of the vehicle 2 is supplied.

The lid 6 covering the inlet 7 is arranged forward of a left front door 4 and above a wheel arch 5 of a left front wheel. A garnish 10 constituted of resin is attached to the body 3 along the wheel arch 5 of the left front wheel. In FIG. 1, the garnish 10 is shown in gray for easier understanding. Although the garnish 10 is shown in gray in FIG. 1, the actual garnish 10 may be in any color.

The garnish 10 protects a fender of the left front wheel and improves the appearance of the body 3 aesthetically. The garnish 10 also covers a part of the lid 6. The resin garnish 10 also protects the lid 6.

The garnish 10 is divided into a body-side garnish 11 and a lid-side garnish 12. The body-side garnish 11 is attached to a surface of the body 3, and the lid-side garnish 12 is attached to a surface of the lid 6. The body 3 and the lid 6 are constituted of metal. Since the lid-side garnish 12 is separate from the body-side garnish 11, the lid 6 to which the lid-side garnish 12 is attached can be opened and closed.

The body-side garnish 11 attached to the body 3 and the lid-side garnish 12 attached to the lid 6 configure one garnish 10 in a visual sense.

A border 10a of the garnish 10 extends continuously in a smooth curved line from the body 3 over to the lid 6. In other words, a border of the body-side garnish 11 is continuous with a border of the lid-side garnish 12 in a straight line or a curved line. Since the border 10a of the garnish 10 extends in a smooth curved line, the appearance of the body 3 is improved aesthetically.

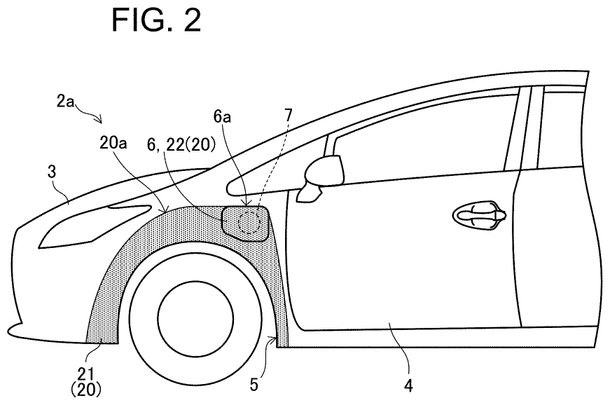

FIG. 2 shows a left side view of a vehicle 2a according to a first variant. In the vehicle 2a, a border 20a of a garnish 20 overlaps an upper portion 6a of a border of the lid 6. This decreases the number of visible lines on the body 3 as compared to a case in which the upper portion 6a of the border of the lid 6 is separate from the border 20a of the garnish 20, simplifying the appearance of the body 3. In the first variant as well, the garnish 20 is divided into a body-side garnish 21 and a lid-side garnish 22. The body-side garnish 21 is fixed to the body 3, and the lid-side garnish 22 is fixed to the surface of the lid 6. The body-side garnish 21 and the lid-side garnish 22 configure one garnish 20 in a visual sense.

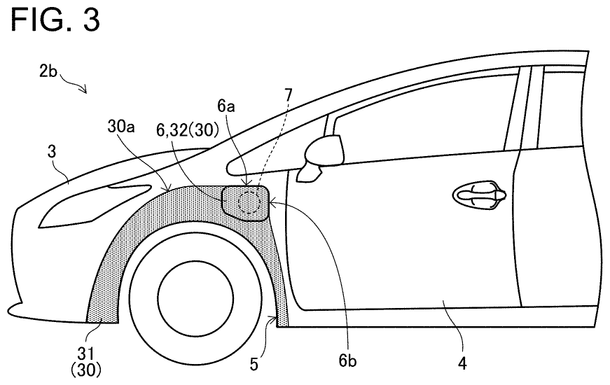

FIG. 3 shows a left side view of a vehicle 2b according to a second variant. In the vehicle 2b, a border 30a of a garnish 30 overlaps both the upper portion 6a and a side portion 6b of the border of the lid 6. This simplifies the appearance of the body 3 further since the number of visible lines on the body 3 is even less. In the second variant as well, the garnish 30 is divided into a body-side garnish 31 and a lid-side garnish 32. The body-side garnish 31 is fixed to the body 3 and the lid-side garnish 32 is fixed to the surface of the lid 6. The body-side garnish 31 and the lid-side garnish 32 configure one garnish 30 in a visual sense.

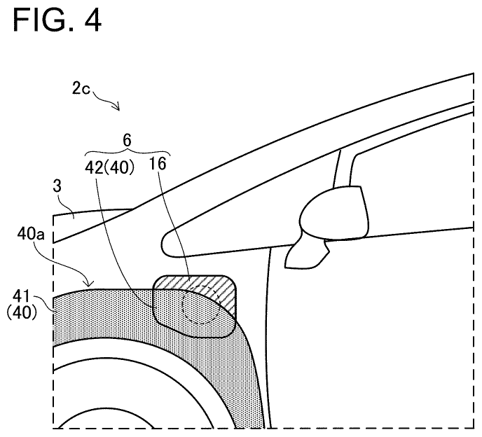

FIG. 4 shows a side view of a vehicle 2c according to a third variant. In the third variant, the shape of a garnish 40 is the same as that of the garnish 10 of FIG. 1. A body-side garnish 41 is the same as the body-side garnish 11 of FIG. 1. In the third variant, a part of the lid 6 is constituted of resin, and this part configures a lid-side garnish 42. A remaining part 16 of the lid 6 is constituted of metal. A border of the lid-side garnish 42, which is a part of the lid 6, and a border of the body-side garnish 41 are continuous in a smooth curved line and configure a border 40a of the garnish 40.

As described above, the vehicle 2 (also each of the vehicles 2a to 2c) includes the garnish 10 (corresponding one of the garnishes 20 to 40) that covers at least a part of the surface of the body 3 and at least a part of the surface of the lid 6. Arranging the lid 6 within a range of the garnish increases a degree of freedom in layout of the lid 6 (inlet 7) on the body 3. Therefore, spatial efficiency inside the body 3 can be improved.

The garnish 10 (also each of the garnishes 20 to 40) is constituted of resin and protects the lid 6. The lid 6 may be constituted of metal or resin. The body 3 is normally constituted of metal.

Some other features regarding the art disclosed in the embodiments will be described. The inlet 7 for energy and the lid 6 covering it may be arranged near a fender of a rear wheel. The inlet 7 and the lid 6 may be arranged in the front part of the vehicle or in a rear part thereof. A plurality of garnishes may be attached to the vehicle. The garnish may cover a part of the surface of the lid 6 or may cover the surface entirely.

The inlet 7 of the vehicle 2 (also each of the vehicles 2a to 2c) is an inlet for electricity (charging socket). The art disclosed herein may be applied to a vehicle including an inlet for gasoline and a vehicle including an inlet for hydrogen fuel. The garnish may be termed a garnish plate.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

What is claimed is:

1. A vehicle comprising:
an inlet provided in a vehicle body and through which energy is supplied to the vehicle;
a lid covering the inlet; and
a garnish constituted of resin, the garnish covering at least a part of the vehicle body and at least a part of the lid.

2. The vehicle of claim 1, wherein a border of the garnish extends continuously from the vehicle body over to the lid in a straight line or a curved line.

3. The vehicle of claim 1, wherein at least a part of a border of the lid overlaps a border of the garnish.

4. The vehicle of claim 3, wherein an upper portion of the border of the lid overlaps the border of the garnish.

5. The vehicle of claim 3, wherein a side portion of the border of the lid overlaps the border of the garnish.

6. The vehicle of claim 3, wherein upper and side portions of the border of the lid overlap the border of the garnish.
